(19) United States
(12) Patent Application Publication
(10) Pub. No.: US 2007/0172623 A1
(43) Pub. Date: Jul. 26, 2007

(54) Optical data store with several storage layers

(75) Inventors: Tobias Kresse, Hamburg (DE); Christoph Jurgens, Hamburg (DE); Kay Schulte-Wieking, Heidelberg (DE)

Correspondence Address: NIXON & VANDERHYE, PC, 901 NORTH GLEBE ROAD, 11TH FLOOR, ARLINGTON, VA, 22203, US

(73) Assignee: TESA AG, Hamburg (DE)

(21) Appl. No.: 10/583,118

(22) PCT Filed: Aug. 4, 2004
(86) PCT No.: PCT/EP04/08749

§ 371 Date: Jun. 16, 2006

(30) Foreign Application Priority Data
Dec. 18, 2003 (DE) 103 60 274.7

(51) Int. Cl. B32B 3/02

(52) U.S. Cl. 428/64.4

(57) ABSTRACT

An optical data storage device has a number of storage strata (1, 2, 3) arranged one above the other, each of which has a reflection layer, preferably a metal layer (12, 22, 32), which, in a predetermined optical wavelength range, has an initial absorption of at least 5%, preferably at least 10%, and an initial transmission of at least 5%, preferably at least 10%, and the transmission or reflection of which can be varied selectively by thermal treatment. In a method for writing information to such an optical data storage device, the information is introduced into a respective storage stratum (1, 2, 3) by means of a writing laser (40) by local variation of the optical properties, to be precise preferably initially at the storage stratum (1) lying closest to the focusing optical system of the writing laser (40) and progressing from there from storage stratum to storage stratum, the transmission or reflection being set in a respective storage stratum (1, 2, 3) by thermal treatment (41).

The invention relates to an optical data storage device, a method for writing to such an optical data storage device, and also a method for reading out information from such an optical data storage device.

WO 00/17864 A1 describes a data storage device with an optical information carrier which contains a polymer film set up as a storage layer. The polymer film comprises e.g. biaxially oriented polypropylene. In the case of the previously known data storage device, the polymer film is wound spirally onto a winding core in a plurality of strata, an adhesion layer in each case being situated between adjacent strata. Items of information can be written to the data storage device by locally heating the polymer film with the aid of a writing beam of a writing laser of a data drive, thereby locally changing the refractive index, density and/or morphology of the polymer film and the reflectivity at the interface of the polymer film. This effect can be intensified by means of a dye that is admixed with the adhesion layers (or additional absorption layers, see, by way of example, WO 02/103689 A1); this absorber dye at least partially absorbs the writing beam and emits the heat generated in the process locally to the polymer film. With the aid of a reading beam in the drive, it is possible to detect the variations of the polymer film since the reading beam is reflected locally to a greater or lesser extent at the interface of the polymer film depending on the information written in. By focusing the writing beam or reading beam, it is possible for information to be written to or read from a preselected stratum of the information carrier in a targeted manner.

Writable optical data storage devices with multiple strata represent a challenge if it is important to ensure fast write and access times in all the strata.

Fast write times necessitate a high absorption of the stratum to be written to and also a high laser intensity available in the corresponding stratum. A high reflection (mirroring) of the corresponding stratum is additionally necessary for a reliable writing and reading process. These exclude one another, however, since a high mirroring and high absorption of the upper strata attenuate the laser intensity in the lower strata.

During the reading process, which is based on consideration of the reflection signal of the corresponding stratum, the influence of the upper strata on the read signal is twice as great since the laser light has to pass through the upper strata on the way forward and back.

Optical data storage devices are also known from CD and DVD technology. DVDs currently exist in single-stratum writable and two-strata readable form. The two-strata nature is still unproblematic, however, with regard to attenuation of the writing or reading beam. Mention should be made of the Blu-ray disk as the next optical storage medium of the future.

An optical data storage device corresponding to a 10-strata CD has been successfully developed by means of two-photon excitation (Call/Recall, Inc., San Diego/Irvine, Calif., USA).

It is known that thin metal films can absorb electromagnetic waves. The optical properties of thin metal films have also already been successfully calculated to an approximation (inter alia Y. Yagil, M. Yosefin, D. J. Bergmann and G. Deutscher, Scaling theory for the optical properties of a semicontinuous metal film, Phys. Rev. B 43, No. 13 (1991)).

Further publications have proposed thin metal layers (in particular silver, aluminum, copper and gold) as an absorber layer for optical storage media (inter alia K. Baba et al., Write-once optical data storage media with large reflectance change with metal-island films, Applied Optics, Vol. 36, No. 11 (1997)).

DE 101 28 901 A1 describes a method which, in an optical data storage device with multiple strata in which each storage stratum has an absorber layer, bleaches the respective absorber layer after the data have been input, and thus makes more energy available for subsequent writing and reading operations in the lower strata. This type of data storage device requires an absorber layer with an absorber dye for each storage stratum.

It is an object of the invention to provide favorable writing and reading conditions for all storage strata in a simply constructed optical data storage device with multiple strata.

This object is achieved by means of an optical data storage device having the features of claim 1 and a method for writing to such a data storage device having the features of claim 9. Claim 16 relates to a method for reading out information from such a data storage device. Advantageous refinements of the invention emerge from the subclaims.

The optical data storage device according to the invention has a number of storage strata arranged one above the other, each of which has a reflection layer, preferably a metal layer, which, in a predetermined optical wavelength range, has an initial absorption of at least 5%, preferably at least 10%, and an initial transmission of at least 5%, preferably at least 10%, and the transmission or reflection of which can be varied selectively by thermal treatment. When the term “metal layer” is used hereinafter, this does not preclude the use of a nonmetallic reflection layer that otherwise has the claimed properties. The reflection layer or metal layer is preferably thinner than 100 nm, in particular thinner than 50 nm. Examples of suitable metals are silver, aluminum, copper, gold or titanium; mixtures or alloys are also suitable.

Thin metal films (metal layers) exhibit a region of strong absorption in their optical properties (besides a transmission that decreases and a reflection that increases as the layer thickness increases). Thus, at specific layer thicknesses, metal films can achieve an absorption of 30% or more. The optical properties greatly depend on the way in which the metal layer is applied (sputtering, vapor deposition, etc.). In the case of the optical data storage device with multiple strata according to the invention, thin metal films having high absorption are used as a combined reflection and absorption layer. As a result, a data carrier is provided in the case of which a fast and reliable writing process is ensured by a high reflection (mirroring) and absorption of a given storage stratum during a writing operation for introducing information.

There is a conflict when using metal films as absorption layer and as reflection layer, however, since metal films having suitably high absorption (as required for writing data) generally also have a relatively high degree of reflection (reflection), so that, owing to the resulting relatively low transmission, deeper storage strata are not reached by a writing or reading beam with sufficient intensity.

This conflict is resolved by making use of the fact that the transmission (or the reflection that correlates with the transmission) of a respective metal layer can be varied selectively by thermal treatment (e.g. by irradiation with light). This is because the optical properties of metal layers can be influenced by supplying thermal energy. The reason for this may be, inter alia, a change in the form and size of the metal particles and resultant altered resonance conditions of the plasmons of the metal film.

This effect is exploited in the method according to the invention for writing information to an optical data storage device of the aforementioned type. In this case, the information is introduced into a respective storage stratum by means of a writing laser by local variation of the optical properties, to be precise preferably initially at the storage stratum lying closest to the focusing optical system of the writing laser and progressing from there from storage stratum to storage stratum. The transmission or reflection is set in a respective storage stratum by thermal treatment (preferably by irradiation with laser light).

This enables a writing strategy which writes to the optical data storage device with multiple strata firstly on the side facing the focusing optical system (e.g. a writing lens) and then works through to the last stratum. The reflection layers or metal layers of all the storage strata first of all have a high absorption and a high reflection. Consequently, the desired data can be written to the first stratum rapidly and reliably. The first stratum can thereupon be exposed e.g. a second time continuously with a lower intensity, which effects a thermal treatment of the associated metal layer, so that the reflection of this stratum is lowered to the value of a desired reflection/stratum profile (see below). In this case, the absorption of the stratum is simultaneously reduced, as a result of which more laser intensity for writing data is available in the next storage stratum. This writing strategy thus ensures a sufficient intensity of the writing laser when writing to each storage stratum.

The finished written-to data storage device may finally have a reflection/stratum profile which represents the optimal case for a readable optical data storage device with multiple strata. In this case, the transmission and reflection of the individual storage strata are set such that, when reading out data, the read signals which are reflected from the individual storage strata, and are preferably generated by means of a reading laser, have a maximum possible intensity that is approximately of identical magnitude for the individual storage strata. Other reflection/stratum profiles are also possible.

In preferred embodiments of the invention, each storage stratum has a polymer layer adjacent to the reflection layer or metal layer, the physical properties, preferably optical properties, of which polymer layer can be varied locally by heating. Preferably, the polymer layer is stretched, in particular biaxially stretched, and may contain e.g. polypropylene, polyvinyl chloride, polyethylene terephthalate, polyethylene naphthalate, polycarbonate, polyamide, polystyrene, polymethylene methacrylate, polymethyl-pentene, polyimide and/or polyalkyl methacrylate. Energy is stored in such polymer layers during production, in particular stretching, and leads to a local restructuring in the event of local heating, thereby e.g. locally changing the refractive index, density and reflectivity. This can be utilized for storing information. The typical size of a storage location for one bit is approximately 1 μm² or (particularly at short wavelengths of a writing or reading laser) less. In these embodiments, the absorption in the reflection layer or metal layer assigned to a given storage stratum can be utilized for heating the polymer layer, the heat being transferred from the metal layer to the adjacent polymer layer and leading to a change in the optical properties locally there. In principle, however, it is also conceivable to provide an absorber dye (e.g. in the polymer layer) (see e.g. WO 02/103689 A1). Furthermore, the storage strata may also contain other layers as well, e.g. an adhesion layer.

When using such a polymer layer, the information that is input is stored in the polymer layer. Since the transmission or reflection of the metal layer can be varied selectively by thermal treatment, it is also possible, however, to utilize the metal layer itself as a storage location.

The optical data storage device according to the invention may be present in a variety of basic forms, e.g. as a disk or as a cylinder (with a concentric arrangement of the storage strata). A further possibility is a cylinder like basic form with a spiral arrangement of the storage strata (see e.g. WO 00/17864 A1); such a basic form arises by winding up a storage stratum (or else a plurality of storage strata arranged one above the other) and fixing it in the wound-up state.

A writing strategy in which the transmission or reflection is set in the storage stratum written to last by subjecting the entire storage stratum to a thermal treatment after the introduction of the information has already been presented.

In an alternative method, the transmission or reflection properties are set in the storage stratum written to last by that region of the storage stratum that has just been written to being irradiated with a laser beam immediately after the writing of data. This avoids the relatively lengthy treatment operation in the case of the abovementioned writing strategy, which has to be effected each time a storage stratum has been completely written to.

A method in which the transmission or reflection is set in the storage stratum written to last by the interspaces between the data structures being irradiated with a laser beam during the writing of data, preferably by means of the writing laser, works even faster. The irradiation of the interspaces is generally effected with a lower intensity than the irradiation for producing the data structures themselves. However, since the position of the data structures and of the interspaces is already known before the driving of the writing beam, an additional work operation for setting the transmission or reflection can be entirely obviated with this strategy. During the production of the data structures, the metal layer generally changes its reflection behavior in the desired direction, so that not just the transmission or reflection of the interspaces is set in a favorable manner in this strategy. The data structures mentioned do not have to be introduced into the metal layer, but may also be produced in an adjacent polymer layer (see above).

In order to improve the writing process, it may be advantageous if the writing laser operates in different wavelength ranges and/or a plurality of writing lasers are provided which operate in different wavelength ranges, a predetermined wavelength range being assigned to a predetermined storage stratum.

Accordingly, for reading out information from an optical data storage device, if, in order to generate read signals, the beam of a reading laser is reflected at a storage stratum onto which it is focused and the read signals are detected, it may be advantageous if the reading laser operates in different wavelength ranges and/or a plurality of reading lasers are provided which operate in different wavelength ranges, a predetermined wavelength range being assigned to a predetermined storage stratum.

The invention thus provides a writable optical data carrier with multiple strata which has a functional layer (or else a plurality thereof) in each storage stratum, said functional layer(s) providing for absorption and reflection of writing laser light during the writing operation and for reflection during the reading operation. The requirements made of the optical properties of the functional layer may deviate greatly from one another during the writing operation and during the reading operation. Therefore, the invention affords the possibility of creating optimal writing and reading conditions by using suitable functional layers (in particular metal layers) and the corresponding writing strategy. During the writing operation, highly absorbing and reflecting layers are available, which ensure a fast and reliable writing process, while during the reading operation weakly absorbing layers that reflect optimally with regard to the number of strata enable fast access times and an optimal signal yield.

The invention is explained in more detail below on the basis of examples. In the drawings:

FIG. 1 shows a graphical illustration of the optical properties (transmission, reflection, absorption) of thin silver films as a function of the layer thickness (wavelength 633 nm),

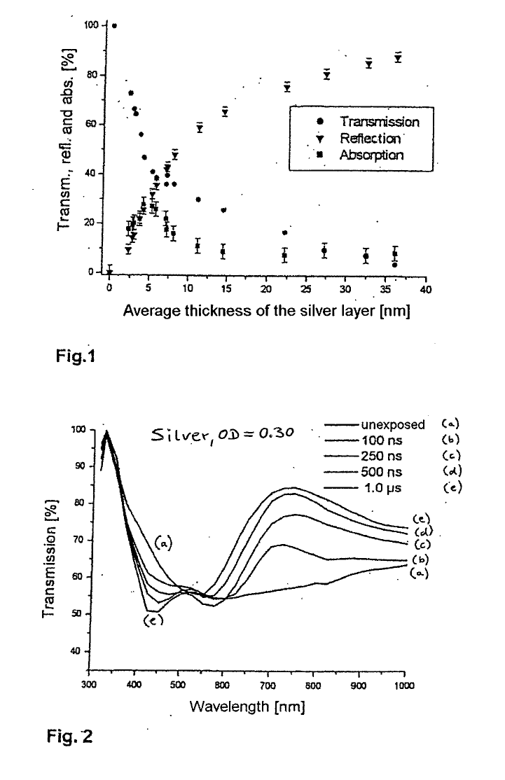

FIG. 2 shows a graphical illustration of the transmission spectra of a silver layer (average thickness approximately 10 nm) as a function of the wavelength after thermal treatment by pulsed irradiation with laser light for different pulse durations,

FIG. 3 shows a graphical illustration of the change in the transmission of light (for three different wavelengths) through a silver layer (average thickness approximately 10 nm) after pulsed irradiation with laser light as a function of the pulse duration, and

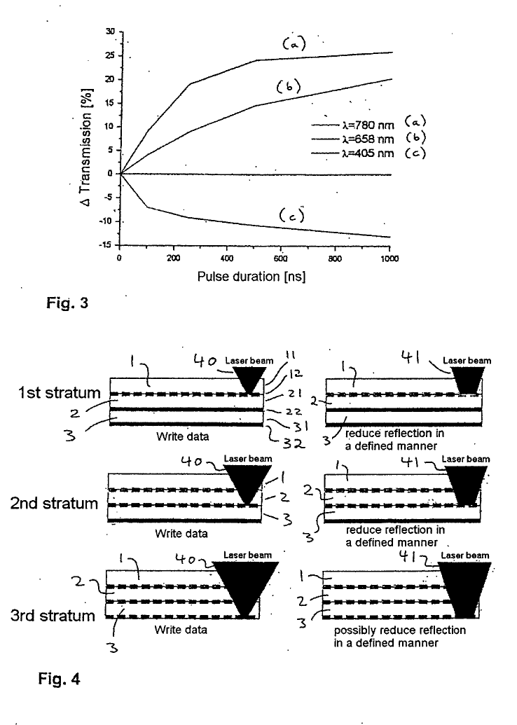

FIG. 4 shows a schematic illustration of a writing strategy for writing to an optical data storage device according to the invention.

If thin metal films are investigated with regard to their optical properties, then they exhibit a region of strong absorption (besides a transmission that decreases and a reflection that increases as the layer thickness increases). Thus, at specific layer thicknesses, metal films can achieve an absorption of 30% or more. The optical properties depend greatly on the way in which the metal layer is applied (sputtering, vapor deposition, etc.). FIG. 1 illustrates the profile of the optical properties of thin silver films as a function of the layer thickness.

Metal films having high absorption can be used as combined reflection and absorption layer for optical data storage devices with multiple strata. Experiments have shown that clearly visible exposure effects can already be obtained with pulse durations of approximately 100 ns given a laser power of approximately 12 mW on an area of approximately 1 μm². Fast writing times are thus ensured.

A more precise investigation of the exposure effects reveals that the supply of thermal energy by the laser varies the optical properties of metal layers. The reason for this may be, inter alia, a change in the form and size of the metal particles and resultant altered resonance conditions of the plasmons of the metal film. FIG. 2 illustrates the spectra of silver layers exposed to different extents in the visible and near infrared wavelength ranges.

Consequently, the transmission of thin metal films can be altered in a targeted manner through different degrees of exposure by means of a laser. When considered at three different wavelengths, the change in the transmission as illustrated in FIG. 3 results for the exemplary silver layer. While the transmission rises for one wavelength range, it can fall for other ranges.

For a storage device with multiple strata, it is possible to determine an optimal reflection/stratum profile which enables the reflected signals of all the strata to be of identical magnitude and maximal during read-out. This profile is as follows for a five-strata system having ideal (absorption-free) reflection layers:

| | |
|---|---|
| 1st stratum: | 12% reflection |
| 2nd stratum: | 16% reflection |
| 3rd stratum: | 23% reflection |
| 4th stratum: | 38% reflection |
| 5th stratum: | 100% reflection |

This profile produces a reflection signal from each layer of approximately 12%.

The reflection/stratum profile is dependent on the number of strata and also the absorption of the individual strata and may therefore turn out different. Furthermore, it may be desirable not to obtain signals of identical magnitude from each stratum, which likewise leads to an altered profile.

In principle, desired degrees of reflection can be realized by metalizing a surface since the degree of reflection can be set very precisely by way of the layer thickness of metal films.

However, there is a conflict between using metal films as absorption layer and as reflection layer since metal layers having suitably high absorption do not necessarily have the (rather low) degrees of reflection that correspond to the optimal reflection/stratum profile of an optical data storage device with multiple strata.

To resolve this conflict it is possible to use a writing strategy which firstly writes to the optical data storage device with multiple strata on the side facing the writing lens of a writing laser and then works through to the last stratum. All the strata initially have a relatively high absorption and a relatively high reflection. Consequently, data can be written rapidly and reliably to the first stratum. The first stratum may thereupon be exposed a second time continuously with lower intensity, so that the reflection of this stratum is reduced to the desired value of the reflection/stratum profile. In this case, the absorption of the stratum is simultaneously reduced, as a result of which more laser intensity is available for writing the data in the next stratum.

All subsequent strata of the optical data storage device with multiple strata can then be written to and “reflection-reduced” in a defined manner in a similar way, so that a completely written-to data carrier having the desired reflection/stratum profile is finally present. FIG. 4 once again illustrates the writing strategy for the example of three strata. The strata are successively written to and reflection-reduced in a defined manner.

FIG. 4 schematically shows an optical data storage device having a first storage stratum 1, a second storage stratum 2 and a third storage stratum 3. In the exemplary embodiment, the first storage stratum 1 contains a polymer layer 11, into which the data structures of the information to be stored are introduced, and also a metal layer 12. The second storage stratum 2 and the third storage stratum 3 correspondingly have a polymer layer 21 and a metal layer 22 and, respectively, a polymer layer 31 and a metal layer 32. In the exemplary embodiment, the polymer layers 11, 21 and 31 in each case comprise biaxially stretched polypropylene having a thickness of 35 μm and the metal layers in each case comprise silver having a thickness of approximately 10 nm.

Data are first of all introduced into the first storage stratum 1 (FIG. 4, top left). This is done by using a laser beam (writing beam 40 of a writing laser) which is focused onto the metal layer 11 and is absorbed in the metal layer 11. At this point in time, the metal layer 11 still has relatively high absorption (and reflection), so that a relatively high proportion of the writing beam 40 is absorbed in the metal layer 11 and only a relatively small proportion passes to the deeper storage strata 2 and 3. The heat generated by the absorption is transferred to the polymer layer 11, where it effects a local change in the refractive index (see above) which represents the stored data (data structure).

Once the first storage stratum 1 has been provided with data, the writing beam 40 is slightly defocused and, as irradiation beam 41, heats the metal layer 11 over a large area by moving over the metal layer 11 (FIG. 4, top right). As a result, the reflection and the absorption in the metal layer 11 are decreased, so that more intensity of the writing beam (or of a reading beam for reading out data) is then available for the second storage stratum 2 and the third storage stratum 3.

The corresponding operations for the second storage stratum 2 and the third storage stratum 3 are illustrated in the middle and lower regions of FIG. 4. If the metal layer 31 is associated with the bottommost storage stratum of the data storage device, its reflection can be set as early as during the production of the data storage device such that a later setting by the irradiation beam is unnecessary.

It is also possible to write information directly to a metal layer without using a polymer layer as a carrier for the data structures. In this case, however, a polymer layer may serve as a spacer between the metal layers of adjacent storage strata.

Thus, by way of example, a data structure can be exposed directly into a metal layer by means of a writing laser, so that it can be read out in reflection. The written-to region may subsequently be partly reflection-reduced by means of a slightly defocused laser beam. During read-out in reflection, an attenuation of the reflection is exhibited but by the same token a higher intensity of the writing beam or reading beam is available for subsequent storage strata.

The writing strategy described is only one of a number of possibilities. In variants, the reflection reduction may be effected by a second, slightly offset laser spot directly after the writing of the data and, consequently, does not require additional writing time. On the other hand, instead of not writing to the interspaces between the data structures during the writing process, it is possible to write to them with weaker pulses and thus to completely avoid an additional reflection reduction operation.

The reduction of the reflection of the layers is based on a thermal effect. Any other form of adding thermal energy may likewise be used as a reflection reduction measure.

As described further above, in specific wavelength ranges, the reflection of the metal layer of a storage stratum can be increased by thermal treatment. It may therefore be expedient, instead of reducing the reflection of the metal layers of the storage strata after data have been written, for said metal layers (or at least one or a plurality thereof) to be mirrored in a defined manner.

It may be advantageous both during the writing process and during the reading process to work in different wavelength ranges (which are preferably generated by more than one laser) and to utilize them in such a way that the functional layers (metal layers) reflect to a greater extent or more weakly depending on the wavelength. As an example, during the reading process, the upper strata may be read at a wavelength of 405 nm since they reflect to a greater extent in this region after the reflection reduction, while the lower layers can be read at a wavelength of 658 nm since they are attenuated less by the upper layers in this region.

In addition, consideration may be given to reducing the reflection of or mirroring the functional layers in stages if this is advantageous for the writing strategy or signal yield.

1. An optical data storage device, having a number of storage strata arranged one above the other, each of which has a reflection layer, preferably a metal layer, which, in a predetermined optical wavelength range, has an initial absorption of at least 5%, preferably at least 10%, and an initial transmission of at least 5%, preferably at least 10%, and the transmission or reflection of which can be varied selectively by thermal treatment.

2. The optical data storage device as claimed in claim 1, characterized in that the transmission or reflection of the reflection layer or metal layer can be varied selectively by irradiation with light.

3. The optical data storage device as claimed in claim 1, characterized in that the reflection layer or metal layer has a transmission in the range of 20% to 90%.

4. The optical data storage device as claimed in claim 1, characterized in that each storage stratum has a polymer layer adjacent to the reflection layer or metal layer, the physical properties, preferably optical properties, of which polymer layer can be varied locally by heating.

5. The optical data storage device as claimed in claim 4, characterized in that the polymer layer is stretched, preferably biaxially stretched.

6. The optical data storage device as claimed in claim 4, characterized in that the polymer layer has at least one of the materials selected from the following group: polypropylene, polyvinyl chloride, polyester, polyethylene terephthalate, polyethylene naphthalate, polycarbonate, polyamide, polystyrene, polymethylene methacrylate, polymethyl-pentene, polyimide, polyalkyl methacrylate.

7. The optical data storage device as claimed in claim 1, characterized in that the reflection layer or metal layer has at least one of the metals selected from the following group: silver, aluminum, copper, gold, titanium.

8. The optical data storage device as claimed in claim 1, characterized in that the data storage device has one of the basic forms selected from the following group: disk-shaped, cylindrical with concentric arrangement of the storage strata, cylinder like with spiral arrangement of the storage strata.

9. A method for writing information to an optical data storage device as claimed in claim 1, the information being introduced into a respective storage stratum by means of a writing laser by local variation of the optical properties, to be precise preferably initially at the storage stratum lying closest to the focusing optical system of the writing laser and progressing from there from storage stratum to storage stratum, the transmission or reflection being set in a respective storage stratum by thermal treatment.

10. The method as claimed in claim 9, characterized in that the thermal treatment is carried out by irradiation with laser light.

11. The method as claimed in claim 9, characterized in that the transmission or reflection is set in the storage stratum written to last by subjecting the entire storage stratum to a thermal treatment after the introduction of the information.

12. The method as claimed in claim 10, characterized in that the transmission or reflection is set in the storage stratum written to last by that region of the storage stratum that has just been written to being irradiated with a laser beam immediately after the writing of data.

13. The method as claimed in claim 10, characterized in that the transmission or reflection is set in the storage stratum written to last by the interspaces between the data structures being irradiated with a laser beam during the writing of data, preferably by means of the writing laser.

14. The method as claimed in claim 9, characterized in that the transmission or reflection of the individual storage strata is set such that, when reading out data, the read signals which are reflected from the individual storage strata and are preferably generated by means of a reading laser, have a maximum possible intensity that is approximately of identical magnitude for the individual storage strata.

15. The method as claimed in claim 9, characterized in that the writing laser operates in different wavelength ranges and/or a plurality of writing lasers are provided which operate in different wavelength ranges, a predetermined wavelength range being assigned to a predetermined storage stratum.

16. A method for reading out information from an optical data storage device as claimed in claim 1, in which case, in order to generate read signals, the beam of a reading laser is reflected at a storage stratum onto which it is focused and the read signals are detected.

17. The method as claimed in claim 16, characterized in that the reading laser operates in different wavelength ranges and/or a plurality of reading lasers are provided which operate in different wavelength ranges, a predetermined wavelength range being assigned to a predetermined storage stratum.
